(19) United States
(12) Patent Application Publication
(10) Pub. No.: US 2013/0111153 A1
(43) Pub. Date: May 2, 2013

(54) DISTRIBUTED STORAGE SYSTEM, APPARATUS AND METHOD FOR MANAGING A DISTRIBUTED STORAGE IN CONSIDERATION OF LATENCY ELEMENTS

(71) Applicant: Ju Pyung LEE, Suwon-si (KR)

(72) Inventor: Ju Pyung LEE, Suwon-si (KR)

(21) Appl. No.: 13/421,228

(22) Filed: Mar. 15, 2012

(30) Foreign Application Priority Data
Nov. 2, 2011 (KR) 10-2011-0113529

(51) Int. Cl. G06F 12/00; G06F 12/02

(52) U.S. Cl. 711/154; 711/E12.009

(57) ABSTRACT

A distributed storage managing apparatus id provided. The distributed storage managing apparatus includes a detector configured to detect a busy storage node having a latency element from among a plurality of storage nodes that distributively store data using a plurality of replicas, and a controller configured to transfer a request associated with data reading or data writing to storage nodes other than the detected busy storage node.

### CROSS-REFERENCE TO RELATED APPLICATION

This application claims the benefit under 35 U.S.C. §119(a) of a Korean Patent Application No. 10-2011-0113529, filed on Nov. 2, 2011, the entire disclosure of which is incorporated herein by reference for all purposes.

### BACKGROUND

1. Field

The following description relates to a distributed storage system, an apparatus, and a method for managing a distributed storage in consideration of latency elements.

2. Description of the Related Art

In general, a distributed storage system may include a plurality of storage nodes, and provide a plurality of clients with storage areas. The clients may be connected to each other through a network.

In response to a client storing data in the distributed storage system, the distributed storage system stores the data in such a way to distribute a predetermined number of replicas of the data to other storage nodes. Thereby, although failures may be generated in some of the storage nodes, the distributed storage system can prevent data loss, and can continue to service data stored in the faulty storage nodes via the other storage nodes.

Meanwhile, in response to a read/write request being transferred to a storage unit, a predetermined latency may be generated according to the characteristics of the storage unit. The storage unit may be included in each storage node. For example, in response to a storage unit included in the storage node being a hard disk drive (HDD), a latency may be generated due to a mechanical characteristic of performing reading/writing operations on a disk that rotates at a constant speed.

### SUMMARY

According to an aspect, a distributed storage managing apparatus is provided. The distributed storage managing apparatus includes a detector configured to detect a busy storage node having a latency element from among a plurality of storage nodes that distributively store data using a plurality of replicas, and a controller configured to transfer a request associated with data reading or data writing to storage nodes other than the detected busy storage node.

Each storage node may include a non-volatile memory.

The detector may detect a storage node that is performing garbage collection, as the busy storage node.

In response to an amount of requests associated with data reading/writing, stored in a queue corresponding to a storage node, exceeding a predetermined threshold value, the detector may detect the storage node as the busy storage node.

In response to an average response time of a storage node exceeding a predetermined threshold value, the detector may detect the storage node as the busy storage node.

The controller may transfer the request associated with data writing to storage nodes having the replicas among storage nodes other than the detected busy storage node.

In response to a predetermined schedule, the detector may detect that storage node as the busy storage node.

The busy storage node may be a single storage node.

In another aspect, a distributed storage managing apparatus is provided. The distributed storage managing apparatus including a group setting unit configured to group a plurality of storage nodes in which data is distributively stored using a plurality of replicas into a plurality of storage groups, a detector configured to detect a busy storage group having a latency element from among the storage groups, and a controller configured to transfer a request associated with data reading or data writing to storage groups other than the detected busy storage group.

Each storage node may include a non-volatile memory.

The detector may detect a storage group including a storage node that is performing garbage collection, as the busy storage group.

In response to an amount of requests associated with data reading/writing, stored in a queue corresponding to a storage node, exceeding a predetermined threshold value, the detector may detect a storage group including the storage node as the busy storage group.

In response to an average response time of a storage node exceeding a predetermined threshold value, the detector may detect a storage group including the storage node as the busy storage group.

The controller may transfer the request associated with data writing to a storage group including storage nodes having the replicas among storage nodes other than the detected busy storage node.

In response to the number of the replicas being K, the number of the storage groups may be set to (K+2).

Each storage group may have a garbage collection allowance mode in which execution of garbage collection is allowed, and a garbage collection prohibition mode in which execution of garbage collection is disallowed, and the garbage collection allowance mode and the garbage collection prohibition mode may be scheduled such that at least (K+1) storage groups are in the garbage collection prohibition mode at an arbitrary time.

The controller may transfer the request to storage groups that are in the garbage collection prohibition mode among the storage groups.

The controller may create a response to the request associated with data reading/writing, the response comprising a global timer including schedule information about the garbage collecting allowance mode and the garbage collection prohibition mode.

A distributed storage managing apparatus is provided. The distributed storage managing apparatus including a distributed storage including a plurality of storage nodes based on non-volatile memory and configured to distributively store data using a replica of the data, a detector configured to detect a busy storage node having a latency element from among the individual storage nodes of the distributed storage, and a controller configured to transfer a request associated with data reading or data writing to storage nodes other than the detected busy storage node.

In another aspect, a distributed storage system is provided. The distributed storage system including a distributed storage including a plurality of storage nodes based on non-volatile memory and configured to distributively store data using a replica of the data, a group setting unit configured to group the storage nodes of the distributed storage into a plurality of storage groups, a detector configured to detect a busy storage group having a latency element from among the storage groups, and a controller configured to transfer a request associated with data reading or data writing to storage groups other than the detected busy storage group.

In another aspect, a method of managing a distributed storage is provided. The method of managing a distributed storage including detecting a busy storage node having a latency element from among a plurality of storage nodes in which data is distributively stored using a plurality of replicas, and transferring a request associated with data reading or data writing to storage nodes other than the detected busy storage node.

In another aspect, a method of managing a distributed storage is provided. The method of managing a distributed storage including grouping a plurality of storage nodes in which data is distributively stored using a plurality of replicas, into a plurality of storage groups, detecting a busy storage group having a latency element from among the storage groups, and transferring a request associated with data reading or data writing to storage groups other than the detected busy storage group.

In another aspect, a device is provided. The device including a distributed storage managing apparatus including a detector configured to detect a busy storage node from among a plurality of storage nodes that distributively store data using a plurality of replicas, and a controller configured to transfer a request associated with data reading or data writing to storage nodes other than the detected busy storage node. Other features and aspects may be apparent from the following detailed description, the drawings, and the claims.

### BRIEF DESCRIPTION OF THE DRAWINGS

FIG. 1 is a diagram illustrating an example of a distributed storage system and a distributed storage managing apparatus.

FIG. 2 is a diagram illustrating another example of a distributed storage system and a distributed storage managing apparatus.

FIG. 3 illustrates an example of storage groups and is a view illustrating an example of a method of scheduling garbage collection (GC) allowance/prohibition modes.

FIG. 4 is a flowchart illustrating an example of a distributed storage management method.

FIG. 5 is a flowchart illustrating another example of a distributed storage management method.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein.

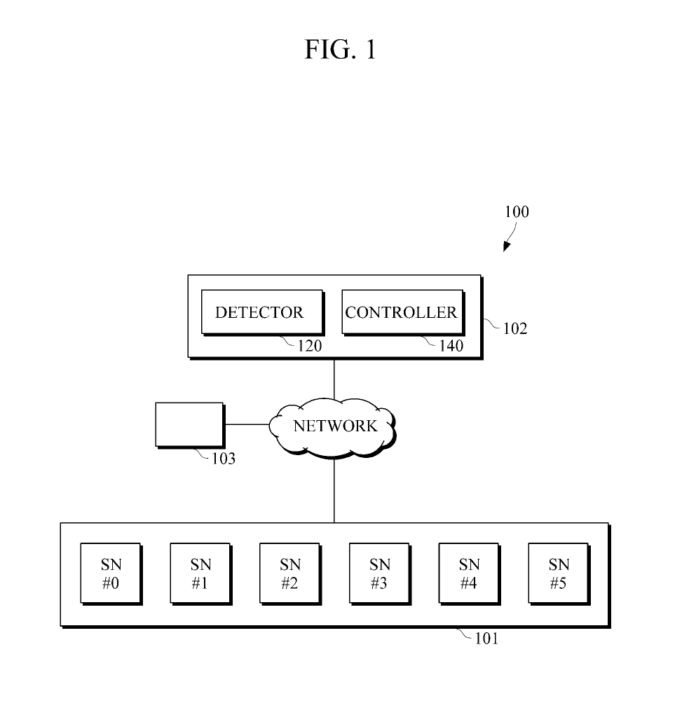

Accordingly, various changes, modifications, and equivalents of the systems, apparatuses and/or methods described herein will be suggested to those of ordinary skill in the art. Also, descriptions of well-known functions and constructions may be omitted for increased clarity and conciseness. FIG. 1 illustrates an example of a distributed storage system 100 and a distributed storage managing apparatus.

Referring to FIG. 1, the distributed storage system 100 may include a distributed storage 101, a distributed storage managing apparatus 102, and a client 103.

The distributed storage 101 may include a plurality of storage nodes. For example, the plurality of storage nodes may be SN #0 through SN #5. In FIG. 1, for convenience, 6 storage nodes SN #0 through SN #5 are shown. However, the number of storage nodes is not limited to 6, and may be less than 6 or more than 6. The distributed storage 101 may store data in the individual storage nodes using a plurality of replicas. In other words, the distributed storage 101 which has received certain data may create a predetermined number of replicas of the data. For example, in the case where data is distributively stored via three storage nodes, the distributed storage 101 may create two replicas of the received data. The original data and the two pieces of replica data may be individually stored in the three storage nodes. Accordingly, the distributed storage 101 may have several storage nodes that each store the same data.

Each storage node of the distributed storage 101 may include a CPU, a memory, a storage, a network interface, etc. For example, each storage node may be a computer apparatus. The computer apparatus may be capable of independently processing a certain work, task, or instruction. Also, the storage nodes can be connected through an external network. The external network may enable the storage nodes to communicate with each other. The external network may be the Internet.

The storage included in each storage node may be a hard disk drive (HDD), a NAND flash, a solid-state drive (SSD), and the like. Among the HDD, NAND flash and SSD, the NAND flash or a SSD-based storage may be selected over the HDD since the HDD may cause latency because of the mechanical characteristics of the HDD while performing reading/writing operations on a disk that rotates at constant speed.

As another aspect, the NAND flash or the SSD have a relatively short latency in comparison to the HDD when performing random reading/writing because the NAND flash or the SSD do not include mechanical elements. Also, since the NAND flash is less expensive and nonvolatile, the NAND flash may be more suited as storage for storage node than the HDD. As another aspect, the NAND flash has a physical characteristic that an operation of writing data onto a certain location of the NAND flash has to precede a delete operation of deleting the entire block, the entire block including the certain location. Accordingly, a time for performing the delete operation may delay processing of a read/write instruction which reaches a NAND flash performing a delete operation. Thus, a NAND flash performing a delete operation may be excluded from processing a read/write operation. As described above, since the distributed storage 101 stores the same data in several storage nodes using replicas of the data, although a specific storage node may be excluded from processing of read/write operation, reading the data from or writing the data in the other storage nodes is possible. Details for the read/write operation will be further described later.

The distributed storage managing apparatus 102 may receive a data request from the client 103 and process the received data request. The data request may be a data write request or a data read request. According to an aspect, the distributed storage system 100 may provide a key-value interface. For example, in response to the client 103 intending to write data in the distributed storage 101, the client 103 may transmit a data write request in the form of {key, value} to the distributed storage managing apparatus 102. In this example, “key” may correspond with the address or ID information of each storage node, and “value” may correspond with data. The distributed storage managing apparatus 102 that has received the data write request may create a predetermined number of replicas and store the original data and the replicas in the individual storage nodes of the distributed storage 101. Also, in response to the client 103 intending to read data from the distributed storage 101, the client 103 may transmit a data read request in the form of {key} to the distributed storage managing apparatus 102. The distributed storage managing apparatus 102 that received the data read request may select a piece of data from among data distributively stored in the storage nodes with reference to a key value, and the distributed storage managing apparatus 102 may transmit the selected data to the client 103.

The distributed storage managing apparatus 102 may include a detector 120 and a controller 140.

The detector 120 may detect a busy storage node from among the storage nodes of the distributed storage 101. The busy storage node may be a storage node with a predetermined latency element. The latency element may be a significant factor that lowers a data read/write speed or degrades system performance. For example, in response to a storage node performing garbage collection, the storage node may not process read/write operations until the garbage collection is terminated. Accordingly, garbage collection may be a latency element. Also, in response to data read/write requests accumulated in a queue of a storage node exceeding a threshold amount, a current data read/write request may not be processed until all of the previous data read/write requests are processed. Thus, the number of data requests stored in a queue may be a latency element. Also, in response to an average response time of a storage node being longer than a predetermined threshold value, the storage node may be considered to have a certain latency element.

Accordingly, the detector 120 may detect a storage node performing garbage collection, as a busy storage node.

According to another aspect, the detector 120 may detect a storage node whose queue stores data requests exceeding a predetermined threshold amount. The storage node may be detected as a busy storage node.

According to another aspect, the detector 120 may detect a storage node whose average response time is longer than a predetermined threshold value. The storage node may be treated as a busy storage node.

The controller 140 may transmit a request related to data reading/writing to storage nodes other than the busy storage node.

For example, the client 103 requests reading of certain data “A”, the data “A” is distributively stored in SN #1 and SN #2, and SN #1 is performing garbage collection are assumed. The controller 140 that received a data read request preliminarily selects SN #1 and SN #2 in which the data “A” is stored. In this case, since the detector 120 detects SN #1 as a busy storage node, the controller 140 finally selects SN #2 from among the preliminarily selected SN #1 and SN #2 because SN #2 is not a busy storage node. Then, the controller 140 reads the data “A” from the finally selected SN #2, and may return the data “A” or metadata related to SN #2 to the client 103.

As another example, the client 103 requests writing of certain data “B”, the distributed storage 101 uses a policy of distributively storing data in two places, and SN #1 is performing garbage collection are assumed. The controller 140 that received a data write request may create a replica of the data “B”. Then, the controller 140 may select storage nodes in which the two pieces of data (for example, the original data and its replica) will be stored. In this case, since the detector 120 detects SN #1 as a busy storage node, the controller 140 transmits the data “B” to storage nodes SN #0 and SN #2 because SN #1 is a busy storage node.

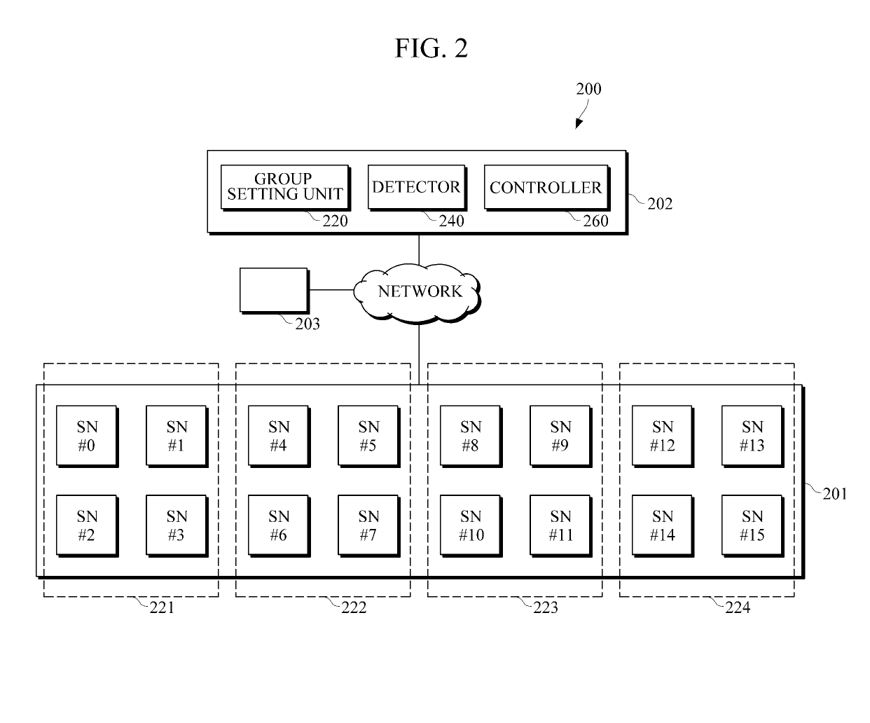

FIG. 2 illustrates another example of a distributed storage system 200 and a distributed storage managing apparatus 202.

Referring to FIG. 2, the distributed storage system 200 may include a distributed storage 201, the distributed storage managing apparatus 202, and a client 203.

The structure of the distributed storage 201 is substantially the same as the structure of the distributed storage 201 described above with reference to FIG. 1.

The distributed storage managing apparatus 202 may receive a data request from the client 203, and process the received data request. Also, the distributed storage managing apparatus 202 may include a group setting unit 220, a detector 240, and a controller 260.

The group setting unit 220 may classify a plurality of storage nodes into N storage groups. For example, the N storage groups may be groups 221 through 224. In other words, the group setting unit 220 may group storage nodes of the distributed storage 201 into a plurality of groups. For example, the storage nodes may be SN #0 through SN #15. For example, the group setting unit 220 may group SN #0 through SN #3 into a first group 221, SN #4 through SN #7 into a second group 222, SN #8 through SN #11 into a third group 223, and SN #12 through SN #15 into a fourth group 224. In this example, the total number of storage nodes, the numbers of storage nodes belonging to each group, and the number of groups to be created are exemplary, and the total number of storage nodes, the numbers of storage nodes belonging to each group, and the number of groups to be created may be variously set to other values according to application purposes.

According to an aspect, the number (that is, the N value) of storage groups to be created may be related to the number of replicas to be created or on the number by which data is distributed. In response to the number of replicas to be created being K and the number of storage nodes in which data is stored being M, the N value may be set to (K+2) or (M+1). For example, in response to certain data being distributively stored in three of the storage nodes of the distributed storage 201, the number of storage groups to be created may be set to four.

The detector 240 may detect a busy storage group having a latency element from among the created storage groups. The latency element may be one of the latency elements described with reference to FIG. 1. For example, the detector 240 may detect a storage group including at least one storage node having a latency element, as a busy storage group.

The controller 260 may transfer a request related to data reading/writing to storage groups other than the busy storage group.

For example, the client 203 requests reading of certain data “A”, the data “A” is distributively stored in SN #0 and SN #4, and SN #0 is performing garbage collection may be assumed. The controller 260 that has received a data read request may preliminarily select the first and second groups 221 and 222 including SN #0 and SN #4 in which the data “A” is stored. In this case, since the detector 240 detects the first group 221 which includes SN #0 as a busy storage group, the controller 260 finally selects the second group 222, which is not a busy storage group, from among the preliminarily selected first and second groups 221 and 222. Then, the controller 260 may read the data “A” from SN #4 of the finally selected second group 222, and may return the data “A” or metadata related to SN #4 to the client 203.

As another example, the client 203 requests writing of certain data “B”, the distributed storage 201 uses a policy of distributively storing data in three places, and SN #0 is performing garbage collection are assumed. The controller 260 that has received the data write request may create two replicas of the data “B”. Then, the controller 260 may select storage nodes where the three data pieces (in other words, the original data B and its replicas) will be stored. In this case, since the detector 240 detects the first group 221 including SN #0 as a busy storage group, the controller 260 may transmit the data “B” to each storage node (for example, the each storage node may be SN #4, SN #8, and SN #12) of the remaining groups 222, 223, and 224 other than the first group 221 which is a busy storage group.

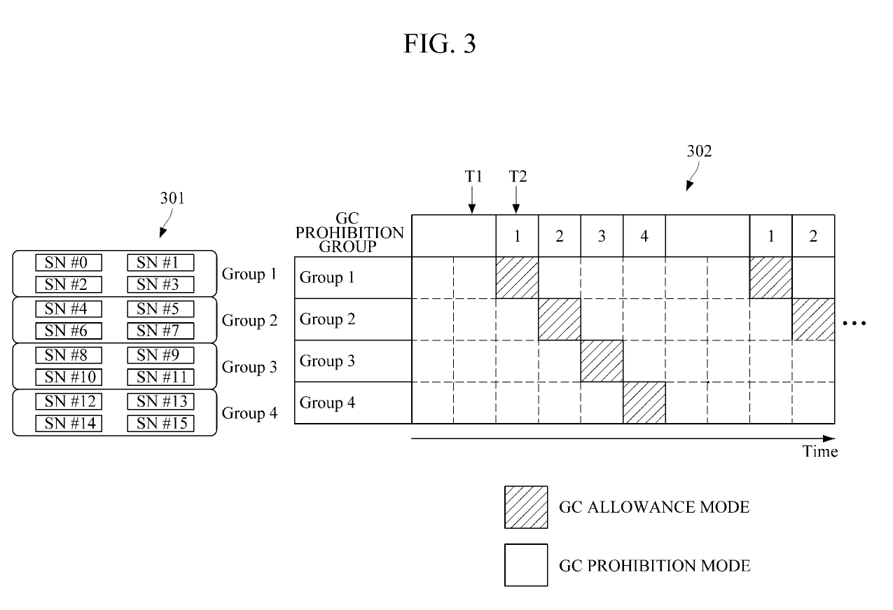

FIG. 3 shows an example of storage groups and illustrates an example of a method of scheduling garbage collection (GC) allowance/prohibition modes.

Referring to FIG. 3, in response to a distributed storage 301 distributively storing N pieces of data, (N+1) storage groups may be created. In other words, in response to the distributed storage 301 creating K replicas, (K+2) storage groups may be created. For example, in response to the distributed storage 301 distributively storing three pieces of data using two replicas, four storage groups may be created.

According to an aspect, each storage group or storage nodes belonging to each storage group may have a predetermined “GC allowance mode” and “GC prohibition mode.” The GC allowance mode may correspond to a mode in which execution of garbage collection (GC) is allowed, and the GC prohibition mode may correspond to a mode in which execution of GC is prohibited. Accordingly, GC may be executed only in the GC allowance mode.

According to another aspect, the GC allowance mode and the GC prohibition mode for the distributed storage 301 may be scheduled according to a predetermined schedule 302. For example, in response to N pieces of data being distributively stored, the GC allowance mode and the GC prohibition mode may be scheduled. In the schedule, at least N storage groups may be in the GC prohibition mode at an arbitrary time. In other words, as illustrated in FIG. 3, in response to four storage groups being created and three pieces of data being distributively stored, the GC allowance and prohibition modes may be scheduled such that at least three storage groups may be in the GC prohibition mode at any time.

According to another aspect, a distributed storage managing apparatus may appropriately schedule the GC allowance and prohibition modes of the individual storage groups, and the distributed storage managing apparatus may transfer a data read/write request to storage groups that are in the GC prohibition mode. An example of the distributed storage managing apparatus may be the distributed storage managing apparatus 202 of FIG. 2. For example, the distributed storage managing apparatus 202 may receive a data read/write request at a time T1 and may transfer the data read/write request to one(s) of the storage groups 1, 2, 3, and 4. Also, the distributed storage managing apparatus 202 may receive a data read/write request at a time T2, may transfer the data read/write request to the remaining groups 2, 3, and 4, and may not transfer the data read/write request to group 1.

According to another aspect, each storage group or storage nodes belonging to each storage group may have a predetermined global timer. The global timer may relate to timing information or schedule information about the GC allowance/prohibition modes described above. The distributed storage managing apparatus 202 may transfer a response to the data read/write request, including a global timer, to a client. The client may relate to a client 203 of FIG. 2. The client 203 may access a storage group other than a storage group entering the GC allowance mode via the global timer. In response to no global timer being used, a storage node that is performing GC blocks read access to itself and transfers the read access to another storage node may be possible.

According to another aspect, the GC allowance mode may function as a latency element. Accordingly, in response to a detector detecting a busy storage group, the detector may detect a storage group that is in the GC allowance mode, as a busy storage group. For example, the detector may correspond to the detector 240 of FIG. 2.

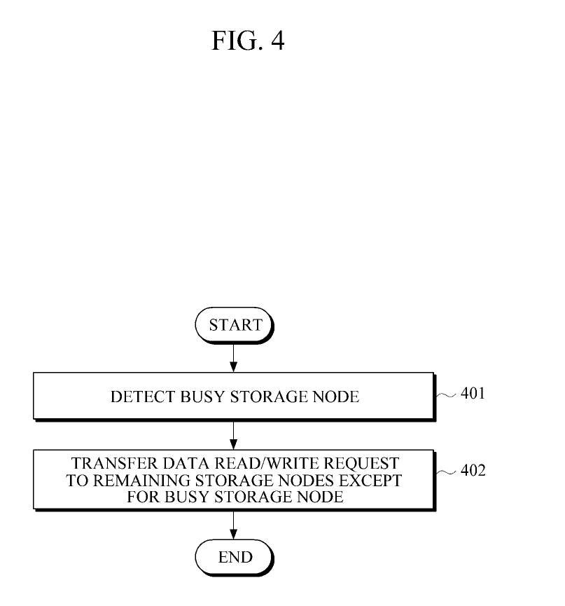

FIG. 4 illustrates an example of a distributed storage management method.

Referring to FIG. 4, first, a busy storage node may be detected (401). For example, the detector 120 of FIG. 1 may detect the busy storage node. The busy storage node may be a storage node having a predetermined latency element among a plurality of storage nodes. The plurality of storage nodes maydistributively store data using a plurality of replicas. The latency element may be an execution of garbage collection (GC), data read/write requests accumulated by a threshold amount or more, a response latency exceeding a threshold time length, etc.

Also, the data read/write request may be transferred to storage nodes other than the detected busy storage node (402). For example, a data read/write request received by the controller 140 of FIG. 1 may be transferred to storage nodes other than a busy storage node.

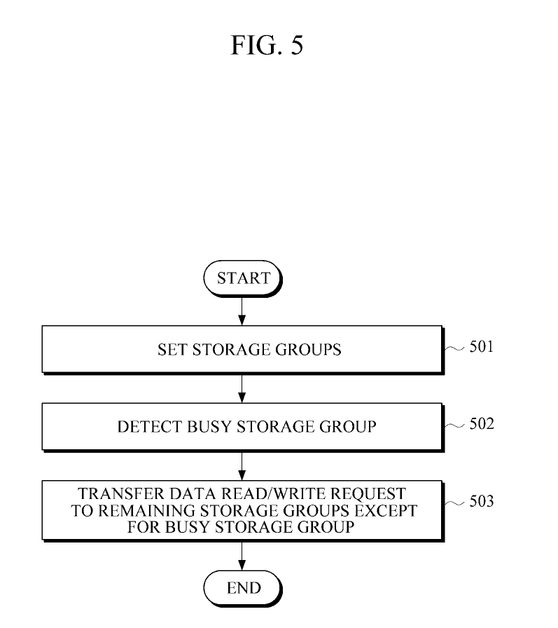

FIG. 5 illustrates another example of a distributed storage management method.

Referring to FIG. 5, first, a plurality of storage groups are established (501). For example, the group setting unit 220 of FIG. 2 may create a plurality of storage groups. The number of storage groups that will be created may be related to the number of data pieces that will be distributively stored or with the number of replicas that will be created.

Then, a busy storage group may be detected (502). For example, the detector 240 of FIG. 2 may detect a storage group including a storage node having a latency element, as a busy storage group.

Also, a received data read/write request may be transferred to storage groups other than the detected busy storage group (503). For example, the controller 260 of FIG. 2 may transfer a received data read/write request to a storage node other than a busy storage group.

According to the examples described above, since a storage node or a storage group including a latency element that delays processing of data reading/writing may be excluded from the processing of data reading/writing, a data read/write request may be quickly processed without any delay.

A computer apparatus may include the storage node.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable recording mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A distributed storage managing apparatus comprising:
a detector configured to detect a busy storage node having a latency element from among a plurality of storage nodes that distributively store data using a plurality of replicas; and
a controller configured to transfer a request associated with data reading or data writing to storage nodes other than the detected busy storage node.

2. The distributed storage managing apparatus of claim 1, wherein each storage node comprises a non-volatile memory.

3. The distributed storage managing apparatus of claim 1, wherein the detector detects a storage node that is performing garbage collection, as the busy storage node.

4. The distributed storage managing apparatus of claim 1, wherein in response to an amount of requests associated with data reading/writing, stored in a queue corresponding to a storage node, exceeding a predetermined threshold value, the detector detects the storage node as the busy storage node.

5. The distributed storage managing apparatus of claim 1, wherein in response to an average response time of a storage node exceeding a predetermined threshold value, the detector detects the storage node as the busy storage node.

6. The distributed storage managing apparatus of claim 1, wherein the controller transfers the request associated with data writing to storage nodes having the replicas among storage nodes other than the detected busy storage node.

7. A distributed storage managing apparatus comprising:
a group setting unit configured to group a plurality of storage nodes in which data is distributively stored using a plurality of replicas into a plurality of storage groups;
a detector configured to detect a busy storage group having a latency element from among the storage groups; and
a controller configured to transfer a request associated with data reading or data writing to storage groups other than the detected busy storage group.

8. The distributed storage managing apparatus of claim 7, wherein each storage node comprises a non-volatile memory.

9. The distributed storage managing apparatus of claim 7, wherein the detector detects a storage group including a storage node that is performing garbage collection, as the busy storage group.

10. The distributed storage managing apparatus of claim 7, wherein in response to an amount of requests associated with data reading/writing, stored in a queue corresponding to a storage node, exceeding a predetermined threshold value, the detector detects a storage group including the storage node as the busy storage group.

11. The distributed storage managing apparatus of claim 7, wherein in response to an average response time of a storage node exceeding a predetermined threshold value, the detector detects a storage group including the storage node as the busy storage group.

12. The distributed storage managing apparatus of claim 7, wherein the controller transfers the request associated with data writing to a storage group including storage nodes having the replicas among storage nodes other than the detected busy storage node.

13. The distributed storage managing apparatus of claim 7, wherein in response to the number of the replicas being K, the number of the storage groups is set to (K+2).

14. The distributed storage managing apparatus of claim 13, wherein each storage group has a garbage collection allowance mode in which execution of garbage collection is allowed, and a garbage collection prohibition mode in which execution of garbage collection is disallowed, and
the garbage collection allowance mode and the garbage collection prohibition mode are scheduled such that at least (K+1) storage groups are in the garbage collection prohibition mode at an arbitrary time.

15. The distributed storage managing apparatus of claim 14, wherein the controller transfers the request to storage groups that are in the garbage collection prohibition mode among the storage groups.

16. The distributed storage managing apparatus of claim 14, wherein the controller creates a response to the request associated with data reading/writing, the response comprising a global timer including schedule information about the garbage collecting allowance mode and the garbage collection prohibition mode.

17. A distributed storage managing apparatus comprising:
a distributed storage including a plurality of storage nodes based on non-volatile memory and configured to distributively store data using a replica of the data;
a detector configured to detect a busy storage node having a latency element from among the individual storage nodes of the distributed storage; and
a controller configured to transfer a request associated with data reading or data writing to storage nodes other than the detected busy storage node.

18. A distributed storage system comprising:
is a distributed storage including a plurality of storage nodes based on non-volatile memory and configured to distributively store data using a replica of the data;
a group setting unit configured to group the storage nodes of the distributed storage into a plurality of storage groups;
a detector configured to detect a busy storage group having a latency element from among the storage groups; and
a controller configured to transfer a request associated with data reading or data writing to storage groups other than the detected busy storage group.

19. A method of managing a distributed storage, comprising:
detecting a busy storage node having a latency element from among a plurality of storage nodes in which data is distributively stored using a plurality of replicas; and
transferring a request associated with data reading or data writing to storage nodes other than the detected busy storage node.

20. A method of managing a distributed storage, comprising:
grouping a plurality of storage nodes in which data is distributively stored using a plurality of replicas, into a plurality of storage groups;
detecting a busy storage group having a latency element from among the storage groups; and
transferring a request associated with data reading or data writing to storage groups other than the detected busy storage group.

21. The distributed storage managing apparatus of claim 1, wherein in response to a predetermined schedule, the detector detects that storage node as the busy storage node.

22. The distributed storage managing apparatus of claim 1, wherein the busy storage node is a single storage node.

23. A device comprising:
a distributed storage managing apparatus comprising:
a detector configured to detect a busy storage node from among a plurality of storage nodes that distributively store data using a plurality of replicas; and
a controller configured to transfer a request associated with data reading or data writing to storage nodes other than the detected busy storage node.
